(19) United States
(12) Patent Application Publication
(10) Pub. No.: US 2014/0255120 A1
(43) Pub. Date: Sep. 11, 2014

(54) Cargo tie down device

(71) Applicants: James Craig Simmons, Nueces County, TX (US); Clayton Mark Jackson, Nueces Country, TX (US)

(72) Inventors: James Craig Simmons, Nueces County, TX (US); Clayton Mark Jackson, Nueces Country, TX (US)

(21) Appl. No.: 13/815,467

(22) Filed: Mar. 5, 2013

(51) Int. Cl. B60P 7/08

(52) U.S. Cl. CPC B60P 7/0823
USPC 410/100

(57) ABSTRACT

A cargo tie down device includes a bracket for mounting on a vehicle such as a truck, trailer, rail car or the like. The bracket may be U-shaped and a hand ratchet may be mounted between the ends of the bracket to wind up a load strap on a spindle rotated by a pivotally mounted handle. A tension release mechanism operates independently of the load strap to safely release the load on the strap. In some embodiments, the bracket slides on a rail of the underside of the vehicle so it may be positioned at any of a series of locations on the vehicle. The device eliminates a conventional removable winch bar and thereby eliminates safety problems associated with winch bars.

This application is based on U.S. Provisional Patent Application 61/634,721 filed Mar. 6, 2012, which is incorporated herein by reference and priority of which is claimed.

This invention relates to a cargo tie down device or strap tightener for securing a load to a vehicle such as a trailer, truck or rail car.

### BACKGROUND OF THE INVENTION

A standard cargo tie down device used on trailers pulled by large trucks is mounted so that it has the ability to slide on a rail running front-to-rear on the bottom of one side of the trailer bed. The tie down device includes a bracket mounted on the rail for movement to a location adjacent the load to be secured to the trailer. The device includes an axle or spindle on which is wound a fabric strap that extends over the load and is secured to the opposite side of the trailer. One end of the axle has a gear and pawl mechanism preventing counterrotation of the axle so that rotation of the axle winds the strap onto the axle and tightens the strap over the load. The opposite end of the axle includes a pair of passages spaced at 90° for receiving a removable winch bar used to rotate the axle.

This standard device has inherent safety problems when tightening the cargo strap. A winch bar or cheater is inserted into the axle opening and force is applied in a downward motion. The tip of the winch bar ought to be inserted completely through one of a pair of passages though the axle. Occasionally, operators insert the winch bar through only one hole to gain a leverage advantage. This can result in tip failure of the winch bar which can lead to injury. The winch bar typically has a curved end, meaning the winch bar can be inserted upside down and so positioned, is prone to failure potentially injuring the operator. Users of this style device occasionally misuse the winch bar because the holes in the axle are located at 90° intervals and, in the tightening operation, leverage is lost as the winch bar moves downwardly. Upon repositioning the bar in the next hole, leverage is often not gained due to the upward angle of the bar. Users often get under the winch bar and hang onto it using body weight to tighten the cargo strap, resulting in possible injury if the winch bar slips.

This standard device also has safety problems when releasing tension in the cargo strap. A winch bar must be inserted into the axle opening and a force applied with one hand to increase tension in the strap and release the pawl from the gear. At the same time, the other hand is used to move the pawl away from the gear to allow counterrotation of the axle. When the user lets up on the winch bar, tension on the load strap causes the axle to counterrotate. Because of the tension in the load strap and the fact that the user can hold the winch bar with only one hand, the winch bar occasionally violently rotates and strikes the user. This problem is aggravated when the individual who tightened the strap is considerably stronger than the individual attempting to release tension in the strap. Serious injuries and death have occurred.

Disclosures of some interest relative to this invention are found in U.S. Pat. Nos. 2,524,406; 5,282,706; 5,542,798; 6,047,989; 6,139,234; 6,457,701 and 7,909,553.

### SUMMARY OF THE INVENTION

The basic concept of this invention is to provide a cargo tie down device or strap tightener capable of being mounted on a vehicle frame to apply and release tension to a load strap in a safe manner without using a removable winch bar. By eliminating the removable winch bar, safety problems associated with the winch bar are also eliminated.

To this end, in one embodiment, a commercially available hand ratchet device is secured to a bracket that slides on a conventional mounting rail of any suitable type below a trailer bed. A simple substitution of a conventional currently commercially available hand ratchet device for the conventional tie down device is not operable because typical commercially available hand ratchet devices are not sufficiently powerful to overcome frictional forces generated between the strap and the trailer and also provide sufficient tension to the load strap. In some embodiments, this is overcome by positioning the hand ratchet in a manner that is mainly inboard of the rub rail so the strap resides in a near vertical plane passing in a slot between the rub rail and the trailer body without rubbing against either. In this manner, frictional forces between the strap and the trailer body are reduced.

Upon first disclosing to a group of experienced truckers, the concept of using a more-or-less conventional hand ratchet type tie down device in lieu of the conventional cheater bar operated tie down device, their opinion was universally that it could not be done.

It is an object of this invention to provide an improved cargo tie down device that is safer in operation than the current industry standard.

A further object of this invention is to provide an improved cargo tie down device or strap tightener that functions without use of a removable winch bar.

A more specific object of this invention is to provide a cargo tie down device that incorporates commercially available components that can be conveniently replaced.

These and other objects and advantages of this invention will become more apparent as this description proceeds, reference being made to the accompanying drawings and appended claims.

### BRIEF DESCRIPTION OF THE DRAWINGS

FIG. 1 is a view of a conventional cargo tie down device mounted on a trailer;

FIG. 2 is a view of one side of an improved cargo tie down device and its connection to a rail on a vehicle illustrating the handle in a retracted or stowed position;

FIG. 3 is a view of the opposite side of the device of FIG. 2 illustrating the rail and vehicle in cross-section;

FIG. 4 is an isometric view of a bracket used in the embodiment of FIGS. 2-3;

FIG. 5 is an isometric view of the device of FIGS. 2-3 viewed from below a trailer body to which the device is attached, with the hand ratchet unfolded;

FIG. 6 is a face on view of the handle assembly and part of the anchor link;

FIG. 7 is a view similar to FIG. 4 illustrating the handle in the middle of a tightening stroke;

FIG. 8 is a face on view, similar to FIG. 6 of the device of FIG. 2 in the configuration of FIG. 3; and

FIG. 9 is a side view of an end of an anchor link connected to a handle assembly.

### DETAILED DESCRIPTION

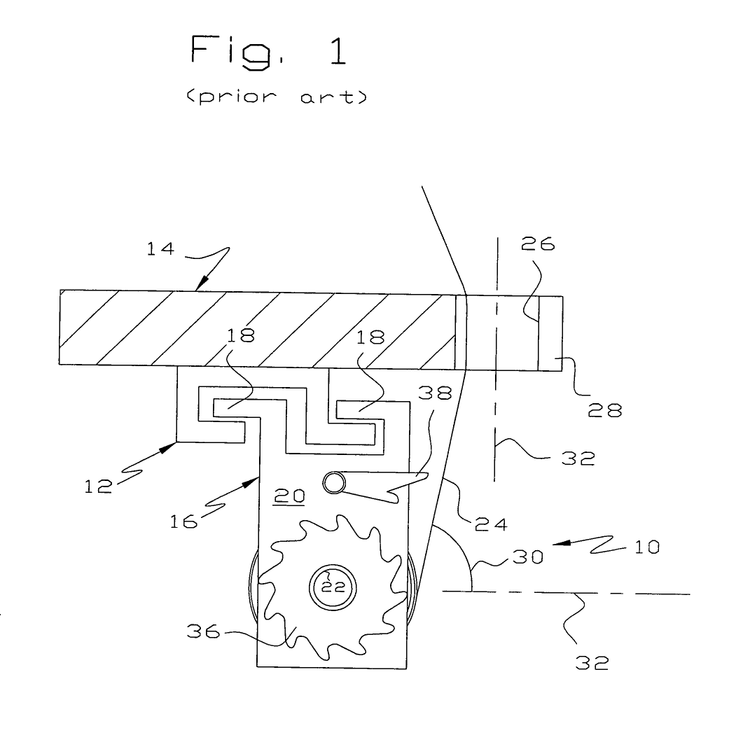

Referring to FIGS. 1, there is illustrated a conventional cargo tie down device 10 mounted on a rail 12 on the underside of a trailer body 14. The tie down device 10 includes a bracket 16 slidably received in the rail 12 so it may be positioned at suitable locations along the length of the trailer body 14. The bracket 16 includes a pair of L-shaped shoulders 18 and a pair of depending side walls 20 journalling a tubular spindle or axle 22 which may include a central slot (not shown) into which is threaded a strap 24 so it can wind around the spindle 22. The strap 24 extends upwardly through a gap 26 between the trailer body 14 and a rub rail 28. An opposite end of the strap 22 is connected in any suitable manner (not shown) to the opposite side of the trailer. It will be seen that the spindle 22 is inboard of the gap 26 so the strap 24 defines an acute angle 30 relative to a horizontal plane 32 through the spindle 22. In other words, a vertical plane 34 through the gap 26 is outboard of the spindle 22 and the strap 24 bends around the trailer body 14 on the inboard side of the gap 26.

The device 10 includes a gear 36 rigid with one end of the spindle 22 and a pawl 38 which allows rotation of the gear 36 in one direction and prevents rotation of the gear 36 in the opposite direction. A pair of passages (not shown) spaced at 90° extend through the opposite end (not shown) of the spindle 22 to allow a removable winch bar (not shown) to be used to rotate the spindle 22 to wind up the strap 24 thereby shortening the strap 24 and tightening the strap 24 on the load carried by the trailer body 14. Those skilled in the art will recognize the device 10 and its operation as being exemplary of conventional cargo tie down devices of the type creating those types of safety problems discussed above.

The following description of the preferred embodiments is not, nor is it intended to be, a description of all potential variations of this invention. It will be apparent that many modifications or alterations of various components may be made without departing from the invention and the scope of the invention as measured by the appended claims.

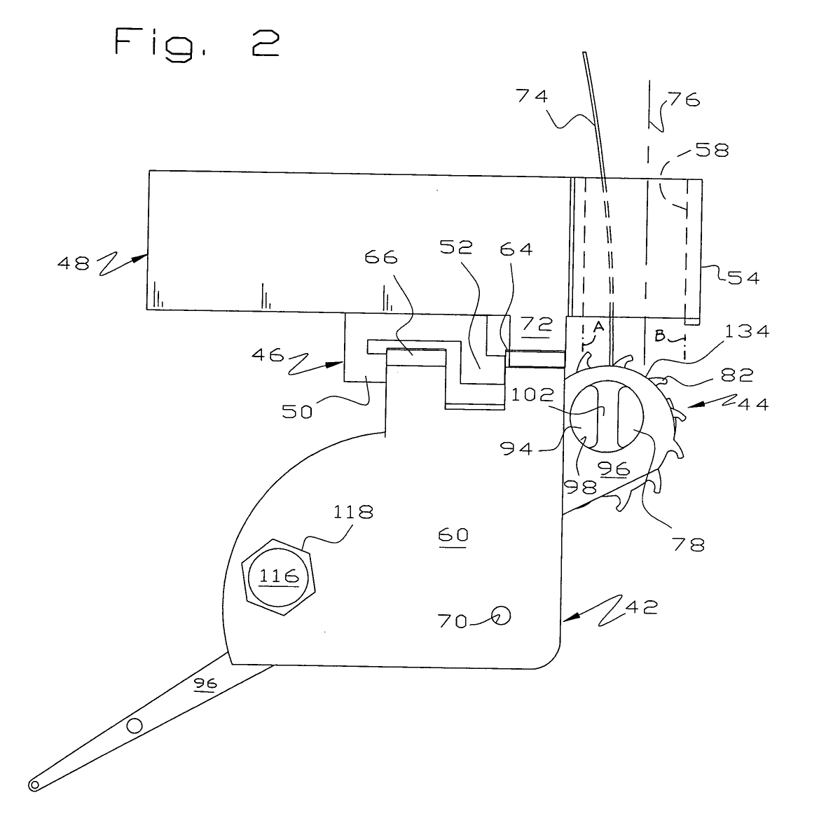

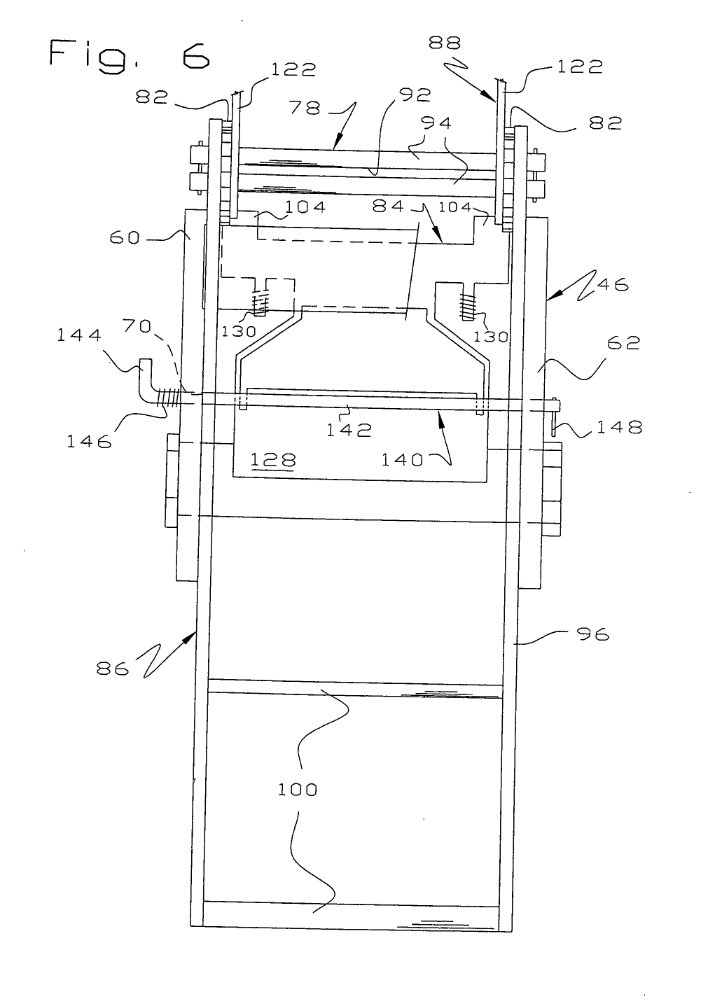

Referring to FIGS. 2-8, there is illustrated one embodiment of an improved cargo tie down device or strap tightener 40 which may be attached to a load carrying vehicle in any suitable manner. The tie down device 40 can comprise, as major components, a bracket 42 and a hand ratchet 44. In some embodiments, one or more rails 46 mounted on a trailer or vehicle body 48 provide a support for the bracket 42 and provide the advantage that the device 40 is adjustable along the length of the trailer body 48. The rails 46 may accordingly be any of the various conventional rail designs or may be of new design. In some embodiments, the bracket 42 may be welded to the vehicle. The rails 46 can include a pair of L-shaped arms 50, 52 supporting the bracket 42. The vehicle or trailer body 48 may include a rub rail 54 spaced from a body portion 56 and providing a gap 58 therebetween.

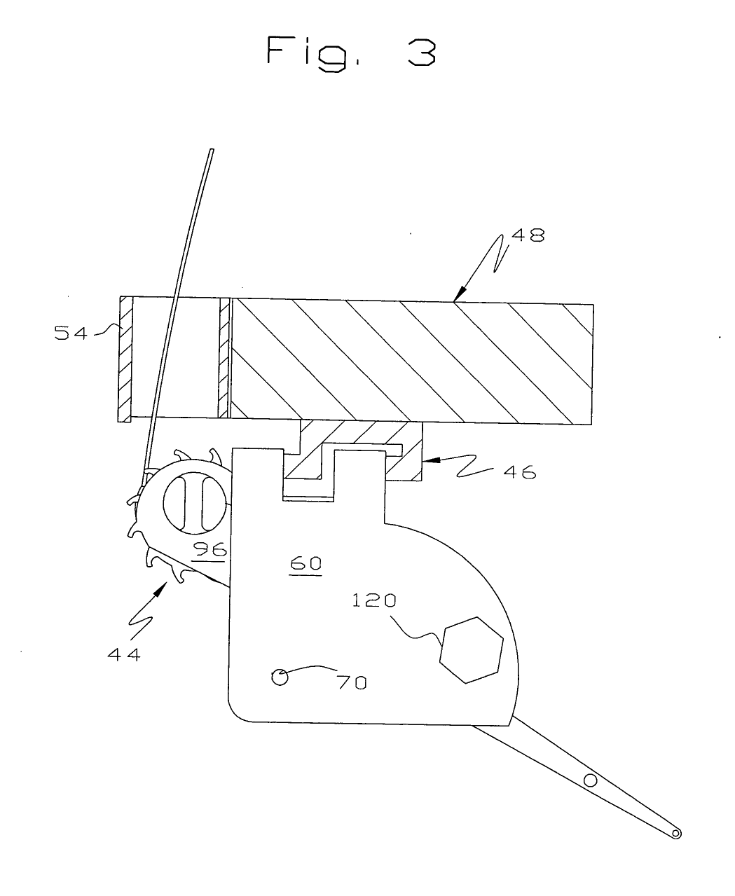

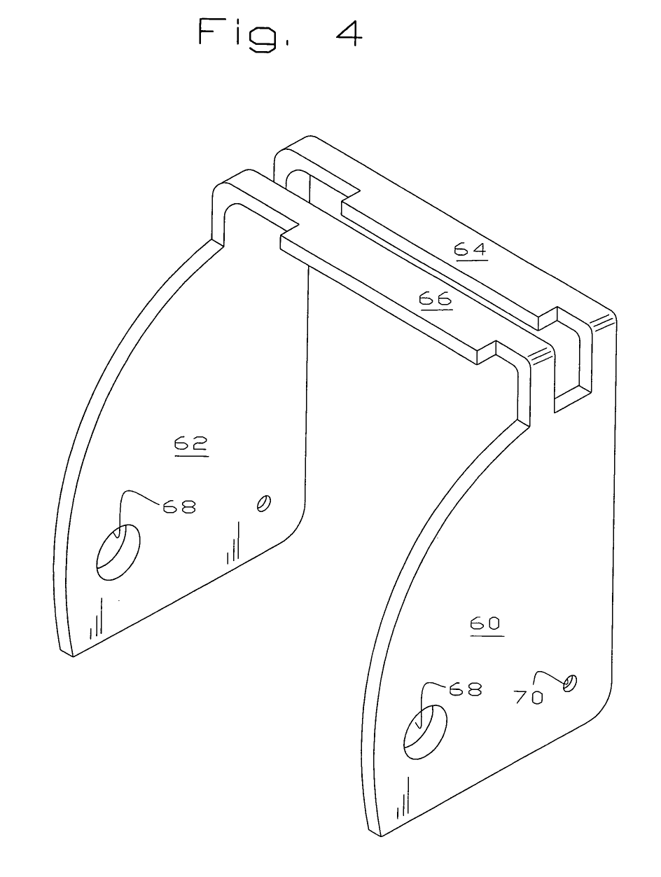

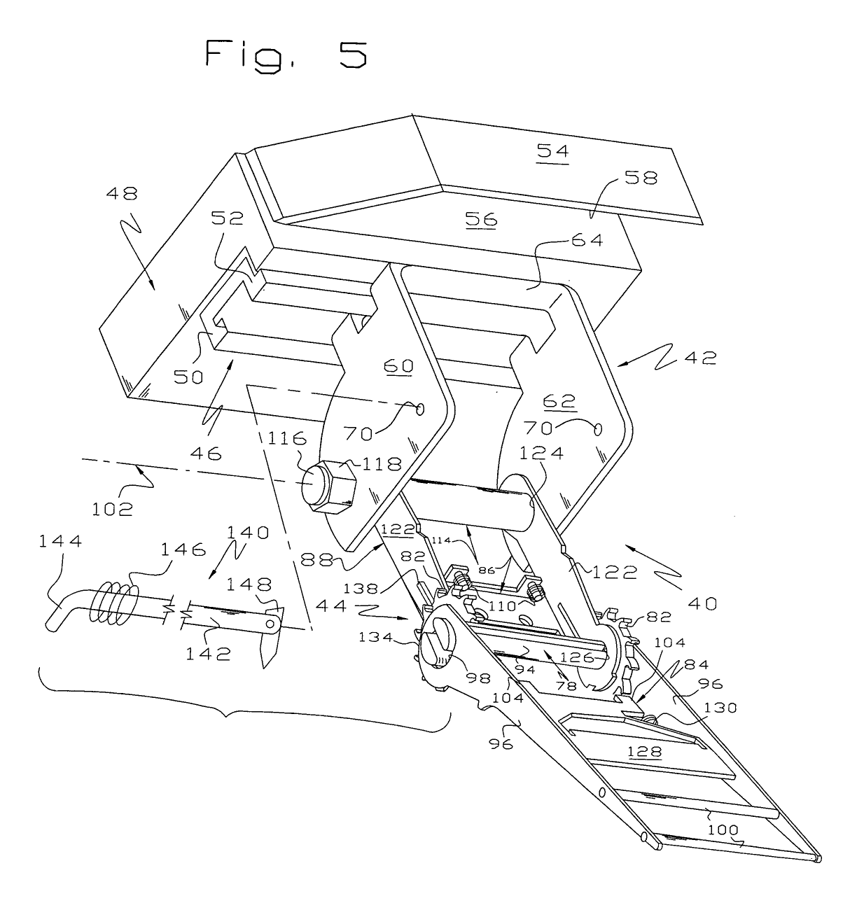

As shown best in FIG. 4, the bracket 42 can comprise a pair of generally mirror image parallel side plates 60, 62 connected by a pair of rigid straps 64, 66. The straps 64, 66 are selected to be of a size and shape to slide on the base of the arms 50, 52 and have sufficient capacity to withstand the load of the hand ratchet 44. The bracket 42 can also include aligned passages 68, 70 for purposes more fully apparent hereinafter. The bracket 42 can be made of any suitable material but is typically of metal and may be stamped from a single blank. As shown best in FIG. 5, the trailer body 48 can include an end plate 72 preventing the tie down device 40 from sliding off the end off the end of the rail 46. Among the purposes of the bracket 42 is to support the hand ratchet from the rail 46 and to position the hand ratchet 44 so its strap 74 extends upwardly through the gap 58 with minimal contact between the rub rail 54 or the trailer body 48 when the strap 74 is under load thereby reducing friction on the strap 74 and allowing an otherwise under powered tightener to adequately tighten the strap 74 and appropriately restrain cargo on the trailer body 48. It will be apparent that conventional hand ratchets which can be used with the bracket 42 produce considerably less force than the conventional tie down device 10 because the cheater bar used with conventional devices may be 4-6′ long while the handle of conventional hand ratchets are on the order of 1′. Thus, the bracket 42 positions the hand ratchet 44 so a vertical plane 76 through the gap 58 is substantially tangent to a spindle 78 of the hand ratchet 44. Viewed somewhat differently, the gap 58 provides a vertical plane A adjacent an inboard edge of the gap 58 and a vertical plane B adjacent an outboard edge of the gap 58 so all or part of the spindle 78 resides between the planes A, B. In addition, the handle assembly 80 resides wholly inboard of the rub rail 54 when the handle assembly 80 is in its stowed position shown in FIGS. 2 and 3.

The hand ratchet 44 can be of a commercially available type such as any of models PT#A-2x27RFH5, PT#A-2x27RFH10, PT#A-3x27RFH-15, PT#A-4x27RFH20 available from Safe 'N Secure USA LP of Dallas, Tex. or similar devices that are available from other manufacturers such as Cargo Equipment Corp. of Elgin, Ill. Reference is made to publications of manufacturers for a more complete description of commercially available hand ratchets. Such hand ratchets 44 can include the strap 74, the spindle 78 mounted for rotation in a handle assembly 80, one or more gears 82, first and second ratchet pawls 84, 86 cooperating with one or more of the gears 82, an anchor link 88 and a tension release mechanism 90.

The strap 74 may be of any suitable type and is currently commercially available from a variety of suppliers.

The spindle 78 can provide a central slot 92 to receive an end of the strap 74 to secure the strap 74 to the spindle 78. In many embodiments, the spindle 78 is of two identical halves 94 spaced apart to provide the slot 92. The spindle 78 extends through the aligned passages 68 and is accordingly mounted for rotation in order to wind up the strap 74. The handle assembly 80 can be of any suitable type and can include a pair of arms 96 providing openings 98 at one end rotatably receiving the spindle 78. The arms 96 can be connected by struts 100 to provide a unitary assembly. The handle assembly 80 is accordingly free to rotate about an axis 102 which passes through the spindle 78.

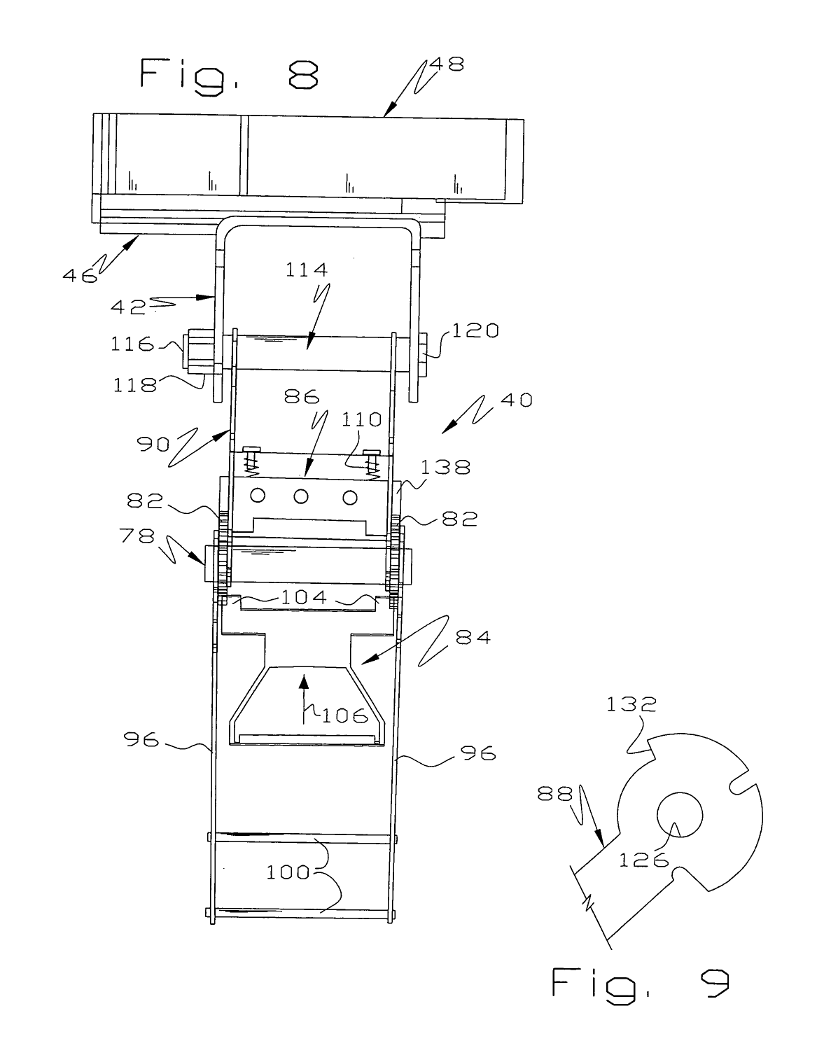

The first pawl 84 is mounted on the handle assembly 80 so oscillation of the handle assembly 80 rotates the gears 82 and tensions the strap 74. The first pawl 84 can include a dog 104 engaging each of the gears 82. The pawl 84 can be movably mounted on the handle assembly 80 in any suitable manner and spring biased toward the gears 82 as suggested by the arrow 106 in FIG. 8. Because of the curvature of the back of the individual teeth on the gears 82, the pawl 84 rides over the back of the individual gear teeth in one direction of movement of the handle assembly 80 but engages the perpendicular face of the gear teeth in the opposition direction of movement of the handle assembly 80. This causes rotation of the spindle 78 in one direction of rotation.

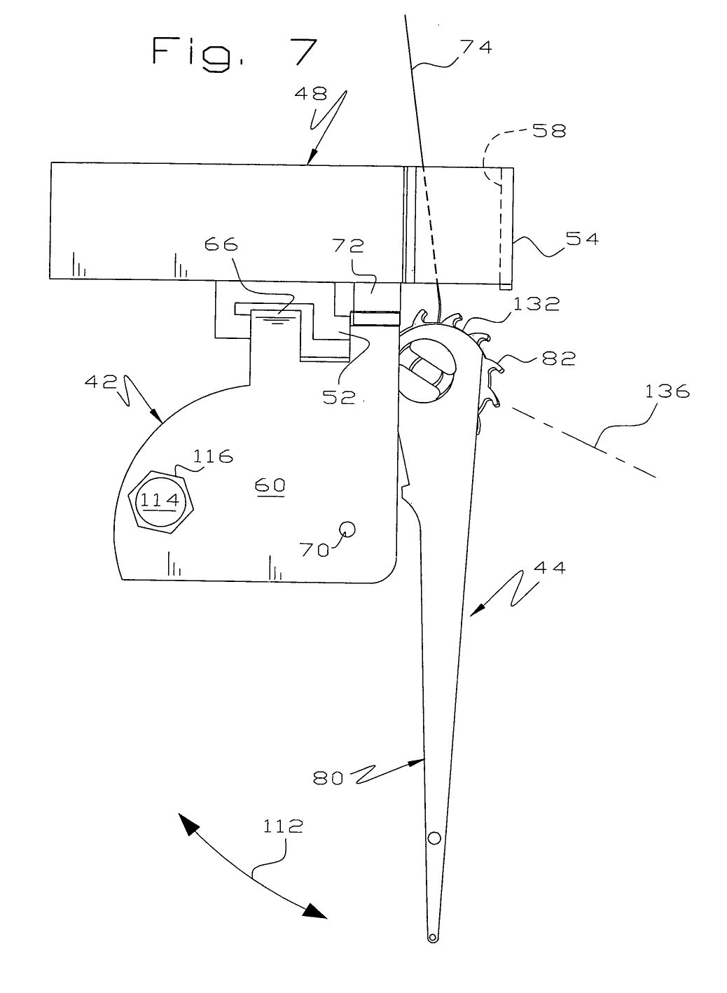

The second pawl 86 is mounted for movement on the anchor link 88 and includes dogs 108 for engaging the gears 82 in a similar manner to the dogs 104 of the first pawl 84. The pawl 86 can be biased by springs 110 toward the gears 82 so the dogs 108 hold the gears 82 and thus the spindle 78 from rotation in a tension relaxing direction. The pawls 84, 86 accordingly act to ratchet the spindle 78 in a strap tensioning direction upon rotation of the handle assembly 80 back and forth between the positions shown in FIGS. 5 and 7 as suggested by the arrow 112.

In a conventional use of the conventional hand ratchet 44, the anchor link 88 connects to a short length of strap (not shown) having a hook (not shown) on the end and the spindle 78 winds up the strap 74 to shorten the effective length of the strap. Instead, as used herein, the anchor link 88 is mounted on a strut 114 extending between the side walls 60, 62 of the bracket 42. The strut 114 can comprise a bolt 116 having a nut 118 on one end and a head 120 on the other. The link 88 can comprise a pair of arms 122 having openings 124 at one end receiving the strut 114 and having openings 126 at the opposite end receiving the spindle 78. The handle assembly 80 can accordingly be pivotally connected to the anchor link 88. An important advantage of this construction is that a conventional hand ratchet 44 can be used and, when it fails or wears out, can be readily replaced by removing the bolt 116, discarding the old hand ratchet and replacing it with a new one. It will also be seen that the bolt 116 binds the side walls 60, 62 together thereby strengthening the bracket 42.

The tension release mechanism 90 may be of any suitable type and can comprise a two part system of which a handle 128 on the first pawl is a part. Pulling on the handle 128 against the bias of a spring 130 biasing the pawl 84 toward the gears 82 disengages the dogs 104 from the gears 82. In normal operation, the handle assembly 80 cannot be rotated counterclockwise from the position shown in FIG. 7 because the pawl 84 contacts an abutment 132 (FIG. 9) on the anchor link 88. Pulling on the handle 128 raises the dogs 104 above the abutment 132 to allow further rotation of the handle assembly 80.

Release of the spindle 78 for movement in the tension relaxing direction does not occur upon disengagement of the pawl 84 because the pawl 86 remains in engagement with the gears 82 preventing rotation of the spindle 78. The second part of the tension release mechanism 90 can be a device to move the pawl 86 out of engagement with the gears 82, such as a cam 134 on the end of the handle arms 96. Thus, activation of the cam 134 can be done by rotating the handle assembly 80 to the position shown by the axis 136 in FIG. 7. This causes the gears 82 to pass under the strap 64 of the bracket 42 so the cam 134 can abut an ear 138 of the pawl 86 (FIG. 8) and push the pawl 86 out of engagement with the gears 82. Disengagement of both pawls 84, 86 from the gears 82 removes any constraint against movement of the spindle 78. This allows tension in the strap 74 to counterrotate the spindle 78 thereby relaxing tension in the strap 74. All of this is done safely by manipulation of the handle assembly 80 and the handle 128 because the cheater bar of the prior art has been eliminated.

Those skilled in the art will recognize the hand ratchet 44 to be typical of conventional hand ratchets used to tie down cargo. Conventional use of the hand ratchet 44 is to attach one strap to the anchor link 88 and wind another strap on the spindle 78. The straps are connected, typically by hooks, to opposite sides of a trailer and the spindle 78 winds up one of the straps to tighten the load.

As is apparent from FIG. 3, when there is no tension on the strap 74, the hand ratchet 44 is free to pivot on the strut 114. To prevent the hand ratchet 44 from swinging freely when not in use, a latch or keeper 140 may be provided. The latch 140 can comprise a pin 142 extending through the aligned openings 70 in the bracket 42 preventing downward pivotal movement of the hand ratchet 44. The pin 142 can have a bent end 144 receiving a spring 146 and an opposite pivoted end 148. When the latch 140 is inserted through the aligned openings 70 and the pivoted end 148 turned transverse to the pin 142, the spring 146 holds the latch 140 securely in place. A tether (not shown) can connect the latch 140 to the device 40.

In some embodiments, a hand ratchet device is incorporated into a bracket that is able to slide on a conventional mounting rail where the hand ratchet device is a modified version of the hand ratchet shown in U.S. Pat. Nos. 5,282,706; 6,139,234 or other similar devices. In some embodiments, the bracket 42 or the hand ratchet 44 can be welded to a vehicle body.

In use, the latch 140 is removed to allow movement of the handle assembly 80 and the strap 74 is unreeled and connected to an opposite side of the trailer body 48 over the top of a piece of cargo (not shown). The handle assembly 80 is then reciprocated between the positions of FIGS. 2 and 7 to wind up the strap 74 on the spindle 78. When the strap 74 is sufficiently tight, the handle assembly 80 is pushed to its retracted position as shown in FIG. 2 and the latch 70 replaced thereby securing the cargo on the trailer body 48.

When it is desired to remove the cargo from the trailer body 48, tension in the strap 74 is released. The latch 140 is removed and the handle assembly 80 moved to the solid line position shown in FIG. 7. The handle 128 is then pulled against the bias of the springs 130 thereby disengaging the pawl 84 from the gears 82. Further movement of the handle assembly 80 to the position of the axis 136 in FIG. 7 causes the cam 132 to push the ear 138 and thereby push the pawl 86 thereby disengaging the pawl 86 from the gears 82. With both pawls 84, 86 disengaged from the gears 82, the spindle 78 is free to rotate in a strap relaxing direction thereby removing tension from the strap 74. The strap 74 can then be unhooked from the opposite side of the trailer body 48 and then rewound on the spindle 78. The handle assembly 80 is folded back into the bracket 42 as shown in FIG. 2 and the latch 140 replaced.

Although this invention has been disclosed and described in its preferred forms with a certain degree of particularity, it is understood that the present disclosure of the preferred forms is only by way of example and that numerous changes in the combination and arrangement of parts, as well as the details of the components, may be resorted to without departing from the spirit and scope of the invention as hereinafter claimed.

We claim:

1. In combination, a vehicle having a rub rail spaced from a vehicle body by a gap and a cargo tie down device comprising
a bracket mounted on the vehicle; and
a hand ratchet mechanism carried by the bracket and including a spindle having a gear thereon for winding a load securing strap therearound, a pivotally mounted handle, first and second pawl mechanisms for ratcheting and thereby rotating the gear in a strap tensioning direction upon pivoting of the handle, and a tension release mechanism for releasing the spindle for rotation in a relaxing direction opposite to the strap tensioning direction;
there being a first vertical plane adjacent an inboard edge of the gap and a second vertical plane adjacent an outboard edge of the gap, the spindle residing at least partly between the first and second planes.

2. The combination of claim 1 wherein the vehicle includes a mounting rail, parallel to the rub rail, having at least one ledge and the bracket includes a mating element slidably supported on the ledge.

3. The combination of claim 1 wherein the bracket is welded to the vehicle.

4. The combination of claim 1 wherein the strap does not frictionally engage the rub rail or the vehicle body.

5. The combination of claim 1 wherein the rub rail defines an outermost position of the vehicle body and the pivotally mounted handle is mounted for movement between a stowed position inboard of the rub rail and a position at least partially outboard of the rub rail applying tension to the strap.

6. The combination of claim 1 wherein the vehicle is a trailer.

7. The combination of claim 1 further comprising a vertical plane extending through the gap and tangent to the spindle.

8. The combination of claim 1 further comprising a third vertical plane through the gap tangent to the spindle so the strap, under load, extends substantially vertically through the gap without touching the vehicle.

9. The combination of claim 1 wherein the bracket includes a pair of generally parallel side walls, the handle residing between the side walls in a retracted handle position and further comprising a removable strut extending between the side walls temporarily restraining movement of the handle to a location between the side walls.

10. The combination of claim 1 wherein the bracket and hand ratchet are connected by an anchor link pivotally connected to the bracket and to the handle.

11. A cargo tie down device comprising
a bracket for mounting the hand ratchet device on a vehicle including a member for slidably abutting a vehicle frame member and at least one side wall transverse to the member;
a hand ratchet device including a spindle having a gear thereon winding a load securing strap therearound, a handle pivotally mounted for movement between a first retracted position and a second position outboard of the bracket, first and second pawl mechanisms for ratcheting and thereby rotating the gear in a strap tensioning direction upon pivoting of the handle, and a tension release mechanism for releasing the spindle for rotation in a relaxing direction opposite to the strap tensioning direction; and
an anchor link securing the hand ratchet device to the bracket including at least one arm having first and second ends, the first end being pivotable relative to the spindle and the second end being pivotally connected to the bracket.

12. The cargo tie down device of claim 11 wherein the first handle position is a stowed position and further comprising means temporarily securing the handle in the first position.

13. The cargo tie down device of claim 11 wherein the bracket includes a pair of generally parallel side walls and further comprising a removable strut extending between the side walls temporarily restraining movement of the handle to the first position.

14. The cargo tie down device of claim 11 wherein the bracket includes a pair of generally parallel side walls and the anchor link comprises a pair of arms generally parallel to the bracket side walls, the arms being pivotally connected to the bracket side walls.

15. The cargo tie down device of claim 14 further comprising a strut spanning the bracket side walls, the arms being pivoted on the strut.

16. The cargo tie down device of claim 15 wherein the strut constrains movement of the side walls away from each other.

17. A cargo tie down device comprising
a bracket for mounting the hand ratchet device on a vehicle including a member for being slidably supported on a vehicle frame member and a pair of side walls transverse to the member; and
a hand ratchet device including a spindle having a gear thereon for winding a load securing strap therearound, a pivotally mounted handle, first and second pawl mechanisms for ratcheting and thereby rotating the gear in a strap tensioning direction upon pivoting of the handle and a tension release mechanism for releasing the spindle for rotation in a relaxing direction opposite to the strap tensioning direction;
the handle being movable between a first position between the bracket side walls and a second position outboard of the bracket side walls.
